(19) United States
(12) Patent Application Publication
(10) Pub. No.: US 2012/0251972 A1
(43) Pub. Date: Oct. 4, 2012

(54) Laser Assisted Periodontium And Osseus Regeneration Protocol

(76) Inventor: Margaret Violett Kalmeta, Aptos, CA (US)

(21) Appl. No.: 13/078,757

(22) Filed: Apr. 1, 2011

(51) Int. Cl. A61C 19/06; A61C 17/20

(52) U.S. Cl. 433/29; 433/215; 433/216

(57) ABSTRACT

A protocol of treating gum disease using a soft tissue diode laser which generates a beam of light having a wavelength in the infrared range at 0.5 to 1.2 watts, used with intermittent stops to control tissue temperature, to decontaminate the gum tissue and biostimulate the periodontium nonsurgically when used with a substrate such as but not limited to enamel matrix proteins, thus preventing the long junctional epithelium from migrating into the sulcus, preserving tissue height, and regenerating periodontium; placing the tip of the laser inside the sulcus; penetrating the entire sulcus by moving the laser light with intermittent stops to control tissue temperature vertically and horizontally throughout the sulcus; and placing a substrate such as but not limited to enamel matrix proteins in the sulcus prior to a blood clot forming nonsurgically when used with the soft tissue diode laser, thus regenerating periodontium in the sulcus.

### BACKGROUND OF THE INVENTION

1. Field of the Invention

The present invention relates generally to an apparatus and method of treating gum diseases and more specifically to a soft tissue diode laser which produces a beam of light having a wavelength in the infrared range at 0.5 to 1.2 watts to treat gum disease.

2. Description of Related Art

Laser Assisted Periodontium And Osseus Regeneration (LAPOR) is a protocol which is laser assisted with the use of a substrate such as but not limited to enamel matrix proteins and thus causes an increase in cell attachment of epithelial cells, gingival fibroblasts, PDL fibroblasts and adhesion of osteogenic cells. This protocol has shown to increase the expression of transcription factors related to the differentiation of osteoblasts/cementoblasts as well as chondroblasts. Enhanced cell migration and proliferation appears to lead to accelerated wound fill rates in vitro using PDL fibroblasts, gingival fibroblasts and osteablast-like cells.

A substrate such as but not limited to enamel matrix proteins, used in the LAPOR protocol, stimulates total protein synthesis and the synthesis of specific extracellular matrix molecules. Studies that evaluate the bone remodeling regulation system indicate that enamel matrix proteins influence this by modulating the OPG and RANKI expression, thus indicating an indirect involvement in the bone remodeling process.

The soft tissue diode laser which produces a beam of light having a wavelength in the infrared range at 0.5 to 1.2 watts, is used in the LAPOR protocol. It has been shown by the LAPOR protocol to biostimulate the healing and regenerative processes of the periodontium, including the biostimulation of new cementum formation on the root surface, Previous studies have shown a positive healing effect of low power laser therapy (infrared range of a soft tissue diode laser) on tissue repair. Low power lasers, in the infrared range, have been shown to positively affect several indices of tissue repair. They biostimulate wound healing by acceleration of collagen synthesis, acceleration of inflammation, decrease of healing time, acquisition of strength. They biostimulate regeneration of tissue via elevated metabolic indices of ATP synthesis, elevated fibroblast proliferation, elevated collagen synthesis and increased indices of biomechanical aspects of tissue healing. The soft tissue diode laser used in the LAPOR protocol, biostimulates the healing response of the periodontium nonsurgically, and biostimulates the tissue regeneration of the periodontium, nonsurgically, and prevents long junctional epithelium from migrating downwards into the sulcus (a biomechanical aspect of tissue healing), thereby preserving the tissue height. A soft tissue diode laser used in the LAPOR protocol helps a substrate such as but not limited to enamel matrix proteins to stimulate total protein synthesis and the synthesis of extracellular matrix molecules, nonsurgically.

### SUMMARY OF THE INVENTION

In an exemplary embodiment of the present invention, there is disclosed a method of treating gum disease using a soft tissue diode laser which generates a beam of light having a wavelength in the infrared range at 0.5 to 1.2 watts to decontaminate the gum tissue and to biostimulate healing and regenerate the periodontium (including cementum of the root surface), thus preventing long junctional epithelium from migrating downwards into the sulcus and thereby preserving the tissue height; The soft tissue diode laser also biostimulates the healing and regenerative response induced by a substrate such as but not limited to enamel matrix proteins; placing the laser inside the sulcus; penetrating the entire sulcus by moving the laser light intermittently vertically and horizontally throughout the sulcus; and placing a substrate such as but not limited to enamel matrix proteins in the sulcus prior to a blood clot forming. (which then increases cell attachment, adhesion, migration and proliferation.)

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 is an X-Ray view of a person's teeth before treatment with a soft tissue diode laser here disclosed which produces a beam of light having a wavelength in the infrared range at 0.5 to 1.2 watts; and before a substrate such as but not limited to enamel matrix protein treatment.

FIG. 2-7 are X-Ray views of the lower teeth of FIG. 1 after treatment with a soft tissue diode laser here disclosed which produces a beam of light having a wavelength in the infrared range at 0.5 to 1.2 watts; and after treatment with a substrate such but not limited to enamel matrix proteins. FIG. 7 shows tissue height preservation and periodontium regeneration.

FIG. 8 is an X-Ray view of the upper teeth before treatment with a soft tissue diode laser here disclosed which produces a beam of light having a wavelength in the infrared range at 0.5 to 1.2 watts and after substrate, such as but not limited to enamel matrix protein treatment;

FIG. 9 is an X-ray view of the upper teeth of FIG. 8 after treatment with a soft tissue diode laser here disclosed which produces a beam of light having a wavelength in the infrared range at 0.5 to 1.2 watts; and after treatment with a substrate such as but not limited to enamel matrix proteins. FIG. 9 shows tissue height preservation and periodontium regeneration.

FIG. 10 is a flow diagram of a method of using a soft tissue diode laser here disclosed which produces a beam of light having a wavelength in the infrared range at 0.5 to 1.2 watts to treat gum disease in accordance with the principles of the invention.

### DESCRIPTION OF THE PREFERRED EMBODIMENT

The LAPOR protocol can be used in the treatment of gum disease by combining the most effective methods of treatment with the use of a special laser. Approximately 66% of the United States population has some form of gum disease. But many avoid seeking treatment because of the discomfort that often results from gum surgery. LAPOR provides a new choice. The LAPOR protocol is a treatment that is more effective as traditional periodontal surgery, and it is much more beneficial to the patient both in the short term and in the long run.

The LAPOR protocol takes only about an hour and only two short follow-up visits. Patients enjoy no downtime with recovery taking only 24 hours. This makes immediate return to work both possible and comfortable.

After having the LAPOR protocol performed, gum recession is minimal to none when compared to that which most often follows normal periodontal surgery. This, combined with new cementum formation on the roots, bone formation in previous defects, periodontal ligament formation and attachment, and gingival height preservation prevents subsequent tooth loss.

The special type of laser used in the LAPOR protocol is the diode, a semiconductor coherent light beam used on soft tissues. The laser light used has a wavelength in the infrared range at 0.5 to 1.2 watts, which disinfects the site, leaving the gum tissue bacteria free, and biostimulates healing; in conjunction with treatment with a substrate, such as but not limited to enamel matrix proteins, the laser biostimulates regeneration of the periodontium. Traditional periodontal therapy removes tissue height of a tooth to reduce the pocket depths. The LAPOR protocol is a regenerative procedure. The patient does not lose tissue volume. Tissue volume is increased and bone is regenerated.

The infrared wavelength is ideally suited for soft tissue procedures since it is highly absorbed by haemoglobin and melanin. This gives the diode laser the ability to, in this case, to target the soft tissues.

The use of the diode laser in conjunction with routine scaling and root planning is more effective than scaling and root planning alone. It enhances the speed and extent of the patients gingival healing and post-operative comfort. This is accomplished through laser bacterial reduction and biostimulation with a laser light having wavelength in the infrared range at 0.5 to 1.2 watts.

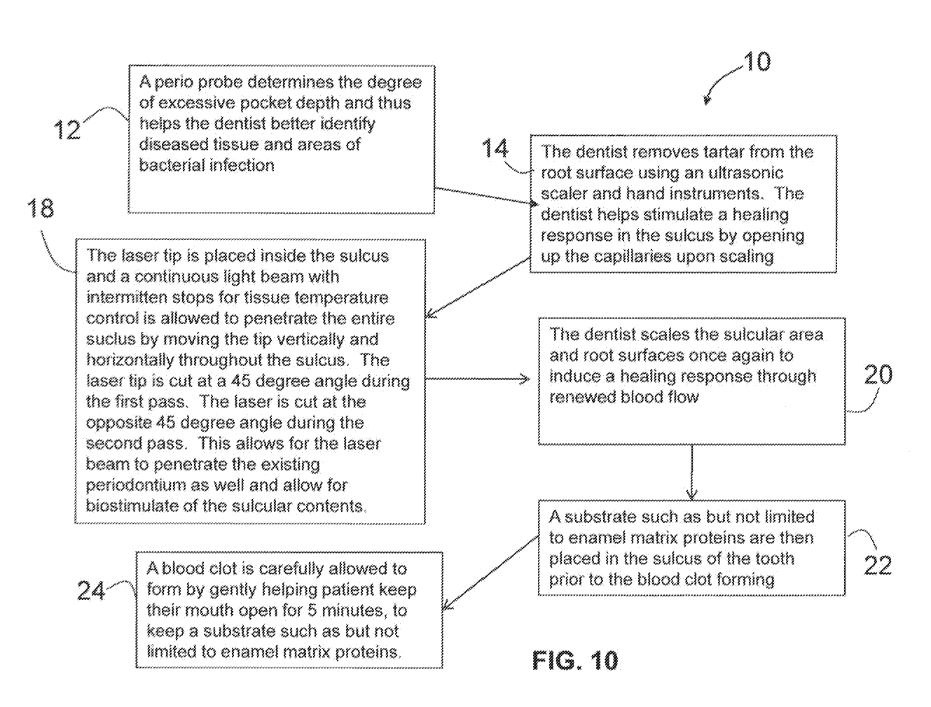

Referring to FIG. 10, there is disclosed a method 10 of using a soft tissue diode laser here disclosed which produces a beam of light, used intermittently, having a wavelength in the infrared range at 0.5 to 1.2 watts to treat gum disease. Starting at block 12, a perio probe determines the degree of excessive pocket depth and thus helps the dentist better identify diseased tissue and areas of bacterial infection. The dentist removes tartar from the root surface using an ultrasonic scaler and hand instruments, block 14. This action by the dentist helps stimulate a healing response in the sulcus by opening up the capillaries upon scaling. Going to block 18, the laser tip is placed inside the sulcus and a continuous light beam with intermittent stops for tissue temperature control is allowed to penetrate the entire sulcus by moving the tip vertically and horizontally throughout the sulcus. The laser tip is cut at a 45 degree angle during the first pass. The laser is cut at the opposite 45 degree angle during the second pass. This allows for the laser beam to penetrate the existing periodontium to decontaminate the tissue, as the heat of the targeted laser light kills the bacteria. This also allows for biostimulation of the sulcular contents. At block 20, the dentist scales the sulcular area and root surfaces once again to induce a healing response through renewed blood flow. Going to block 22, a substrate, such as but not limited to enamel matrix proteins, is then placed in the sulcus of the tooth prior to the blood clot forming and at block 24, a blood clot is carefully allowed to form by gently helping patient keep their mouth open for 5 minutes, to keep the substrate, such as but not limited to enamel matrix proteins intact.

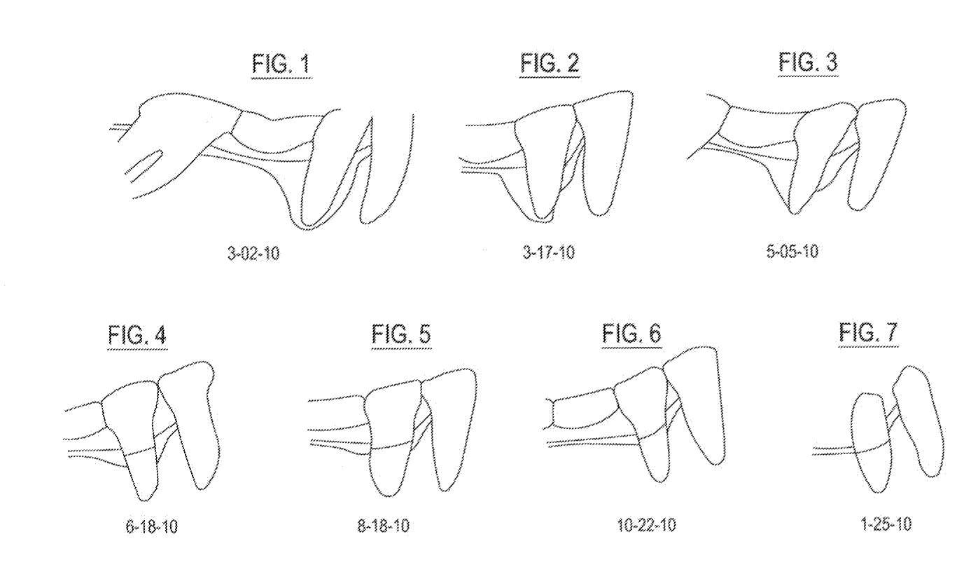

FIG. 1 is an X-Ray view of a person's teeth before treatment with a soft tissue diode laser here disclosed which produces an beam of light having a wavelength in the infrared range at 0.5 to 1.2 watts; and before substrate treatment, such as but not limited to enamel matrix proteins.

FIG. 2-7 are X-Ray views of the lower teeth of FIG. 1 after treatment with a soft tissue diode laser here disclosed which produces a beam of light having a wavelength in the infrared range at 0.5 to 1.2 watts; and after substrate treatment, such as but not limited to enamel matrix proteins. FIG. 7 shows tissue height preservation and periodontium regeneration.

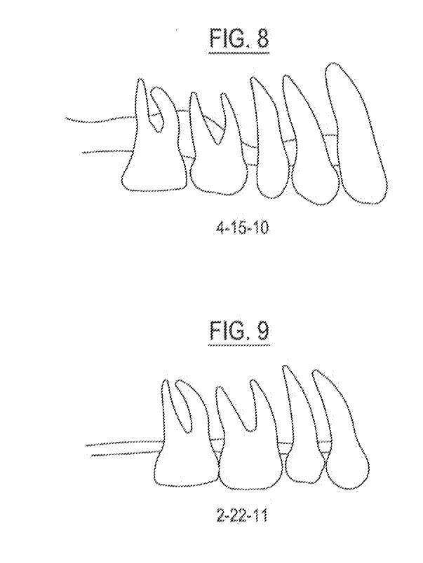

FIG. 8 is an X-Ray view of the upper teeth before treatment with a soft tissue diode laser here disclosed which produces a beam of light having a wavelength in the infrared range at 0.5 to 1.2 watts and after treatment with a substrate, such as but not limited to enamel matrix proteins.

FIG. 9 is an X-ray view of the upper teeth of FIG. 8 after treatment with a soft tissue diode laser here disclosed which produces a beam of light having a wavelength in the infrared range at 0.5 to 1.2 watts; and after treatment with a substrate, such as but not limited to enamel matrix proteins. FIG. 9 shows tissue height preservation and periodontium regeneration.

FIG. 10 is a flow diagram of a method of using a soft tissue diode laser here disclosed which produces a beam of light having a wavelength in the infrared range at 0.5 to 1.2 watts to treat gum disease in accordance with the principles of the invention.

The LAPOR protocol is much less invasive than traditional surgery and offers advantages and benefits over its counterpart. Recovery time is much faster because most, if not all, damage to healthy tissue is avoided through the use of more advanced technology. Because the LAPOR protocol leaves healthy tissue intact, the height of the gums themselves around the teeth is much better preserved. The LAPOR protocol prevents long junctional epithelium from migrating downwards into the sulcus, thus preserving the tissue height in this manner and allowing for the regeneration of the periodontium.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

1-9. (canceled)

10. A method for treating gum disease and associated bacteria in a periodontal pocket, the periodontal pocket being defined by opposing root and periodontium surfaces that are detached from one another, the method comprises the following steps:
Step A: scaling the root surface for detaching bacteria therefrom while simultaneously stimulating the periodontium surface for opening capillaries therein; then
Step B: passing a beam of IR laser light over the root surface for killing bacteria and disinfecting the root surface;
Step C: passing a beam of IR laser light into the opposing periodontium surface for heating and biostimulating the opened capillaries of said Step A in preparation for bleeding therefrom; then
Step D: after heating and biostimulating the opened capillaries in said Step C, scaling the root surface again while simultaneously stimulating the periodontium surface for inducing blood flow and bleeding therefrom for displacing bacteria from the periodontal pocket and filling the periodontal pocket with blood;
Step E: prior to blood clot formation, placing and maintaining a substrate into the periodontal pocket for facilitating and stabilizing blood clot formation therein; and then
Step F: maintaining the substrate of said Step E intact within the periodontal pocket until blood clot formation has occurred;
whereby treatment of the gum disease in the periodontal pocket is facilitated by the disinfection of the root surface by scaling and passing a beam of IR laser light thereover, by the displacement of bacteria from the periodontal pocket by bleeding from the periodontium, and by the subsequent clot formation in the presence of the substrate, clot maintenance, and clot induced healing with the substrate within the periodontal pocket.

11. The method of claim 10 wherein:
in said Step F, the substrate is maintained intact in the periodontal pocket for at least 5 minutes.

12. The method of claim 10 wherein:
in said Step E, the substrate includes an enamel matrix protein.

13. The method of claim 10 wherein:
in said Step C, IR laser light is employed of a type absorbed by haemoglobin and/or melanin and with sufficient duration for heating and biostimulating the opened capillaries.

14. The method of claim 10 wherein:
in said Step A, the stimulation optionally induces bleeding and blood flow; and
in said Step D, the bleeding and blood flow is enhanced over bleeding and blood flow in said Step A due to the heating and biostimulating of the opened capillaries in said Step C;
whereby the displacement of bacteria from the periodontal pocket in said Step D is enhanced as compared to said Step A.

15. The method of claim 10 wherein:
in said Step A, the scaling is selected from a group consisting of ultrasonic scaling, hand tool scaling, and both ultrasonic and hand tool scaling.

16. The method of claim 10 further comprises the following step:
Prior to said Step A, determining the depth of the periodontal pocket.
